(19) United States
(12) Patent Application Publication
(10) Pub. No.: US 2006/0254874 A1
(43) Pub. Date: Nov. 16, 2006

(54) CENTRIFUGALLY ASSISTED CLUTCH

(75) Inventors: James Fox, Sullivan, MO (US); Carl E. Ijames, Sullivan, MO (US)

Correspondence Address: SENNIGER POWERS, ONE METROPOLITAN SQUARE, 16TH FLOOR, ST LOUIS, MO, 63102, US

(73) Assignee: ACE MANUFACTURING & PARTS COMPANY, Sullivan, MO (US)

(21) Appl. No.: 11/460,480

(22) Filed: Jul. 27, 2006

Related U.S. Application Data
(63) Continuation-in-part of application No. 10/728,199, filed on Dec. 4, 2003, now Pat. No. 7,082,661.
(60) Provisional application No. 60/430,969, filed on Dec. 4, 2002.

(51) Int. Cl. F16D 43/24

(52) U.S. Cl. 192/105 C

(57) ABSTRACT

A friction clutch assembly connects driving and driven shafts and has a pressure plate axially moveable between an engaged position transmitting torque from the driving shaft to the driven shaft and a disengaged position. The assembly includes at least one primary lever which pivots relative to the cover and is configured for contact with the pressure plate. This primary lever is spring-biased to pivot in one direction to apply a generally axial primary force urging the pressure plate toward its engaged position, and is adapted to pivot upon release of the spring bias to pivot in an opposite direction thereby to permit movement of said pressure plate to its disengaged position. The assembly also includes at least one centrifugal-assist lever operable on rotation of the cover to pivot relative to the cover to apply a generally axial secondary force to the primary lever to assist in urging the pressure plate to its engaged position.

### CROSS-REFERENCE TO RELATED APPLICATIONS

This application is a continuation-in-part of U.S. Non-Provisional patent application Ser. No. 10/728,199, filed Dec. 4, 2003, which claims priority from U.S. Provisional Patent Application Ser. No. 60/430,969, filed Dec. 4, 2002. The entire text of both applications is hereby incorporated herein by reference.

### BACKGROUND OF THE INVENTION

This invention relates generally to friction clutches, and in particular to a clutch assembly that transmits a calibrated amount of centrifugal force.

Friction clutches are widely used in trucks and other automotive vehicles to selectively connect a driving shaft which is a source of rotational power, such as an engine crankshaft, to a driven shaft, such as a transmission input shaft. A typical clutch has a moveable pressure plate connected for rotation with the driving shaft and a friction disk connected for rotation with the driven shaft. When the pressure plate is moved to a position where it clamps the friction disk in operative engagement with a flywheel on the end of the driving shaft, the driven shaft rotates with the flywheel and torque is transmitted from the driving shaft to the driven shaft. When the pressure plate is moved to a position where the friction disk is disengaged from the flywheel, essentially no torque is transmitted and a driver of the vehicle is free to shift gears of the transmission. Existing clutches to which the present invention applies may include multiple pressure plates and friction disks that are compressed by action of the clutch to engage the flywheel and driven shaft.

One or more springs mounted on the cover plate bias the pressure plate to the position where the friction disk engages the flywheel. In one existing design, a conical spring diaphragm is mounted on the cover to exert an axial force on the pressure plate in its extended conical position and to release the pressure plate when flattened by the force applied by a release bearing initiated by depressing the clutch pedal of the vehicle. The spring must be provided with a tension that is sufficiently high to exert adequate pressure on the pressure plate to prevent slipping of the clutch while still permitting ease of disengagement of the clutch through the clutch pedal of the vehicle. In another existing design, a series of coil compression springs seated on the cover urge a series of levers into pressure engagement with the pressure plate. Depression of the clutch pedal to overcome the force applied by these springs causes the clutch to disengage.

Recent trucks and other automotive vehicles include engines of significantly greater horsepower and torque that require clutches which transmit more power. Each clutch must provide a correspondingly greater plate load to hold the pressure plate in clamped engagement with the friction disk. To facilitate a larger plate load, some clutches include springs of increased size or a greater number of springs (including compression springs) to apply a larger force urging the pressure plate against the friction disk. Unfortunately, these springs can detrimentally increase weight and volume of the clutch. Further, since the driver must oppose a larger spring force when pressing upon the foot pedal, the clutch is more difficult to operate. These clutches are complex, costly, and less reliable. Also, while existing centrifugally assisted clutch designs may reduce the amount of pedal force required to disengage the clutch, these designs have drawbacks.

### SUMMARY OF THE INVENTION

Among the objectives of the present invention may be noted the provision of a clutch assembly having one or more of the following advantages: the provision of such an assembly which is suitable for use in vehicles with higher torque engines; the provision of such a clutch that transmits larger forces without increasing size or weight of the clutch; the provision of such a clutch that transmits larger forces upon increasing rotational speeds; the provision of such a clutch that can be calibrated to exert incrementally larger forces upon incremental increases in rotational speed; the provision of such a clutch that minimizes force that must be applied to disengage the clutch; the provision of such a clutch which is reliable; and the provision of such a clutch that is economical.

In general, a friction clutch assembly of this invention is used for connecting driving and driven shafts, the driving shaft having a flywheel thereon. The clutch assembly comprises a cover adapted to be secured to the flywheel in a fixed axial position relative to the flywheel and for conjoint rotation with the flywheel about an axis of rotation of the driven shaft. A pressure plate is operatively attached to the cover for rotation therewith about the axis of rotation. The pressure plate is axially moveable between an engaged position wherein the pressure plate applies a force to clamp at least one friction disk on the driven shaft into operative engagement with the flywheel on the driving shaft thereby to transmit torque from the driving shaft to the driven shaft, and a disengaged position wherein the pressure plate does not clamp the at least one friction disk and substantially no torque is transmitted. The clutch assembly also includes at least one primary lever adapted to pivot relative to the cover and configured for contact with the pressure plate. At least one primary lever is spring-biased to pivot in one direction relative to the cover thereby to apply a generally axial primary force urging the pressure plate to its engaged position, and the lever is adapted to pivot upon release of the spring bias to pivot in an opposite direction thereby to permit movement of the pressure plate to its disengaged position. At least one centrifugal-assist lever is operable on rotation of the cover to pivot relative to the cover to apply a generally axial secondary force to assist the primary lever in urging the pressure plate toward its engaged position.

Other objects and features of the present invention will be in part apparent and in part pointed out hereinafter.

### BRIEF DESCRIPTION OF THE DRAWINGS

FIG. 1 is a top perspective of a friction clutch assembly of the present invention;

FIG. 2 is an exploded perspective of the clutch assembly;

FIG. 3 is bottom perspective of a cover removed from the friction clutch assembly;

FIG. 4 is a top plan view of the friction clutch assembly;

FIG. 5 is section of the friction clutch assembly taken along the plane indicated by line 5-5 of FIG. 4 and further depicting driving and driven shafts and a flywheel;

FIG. 5A is an enlarged fragment of FIG. 5;

FIG. 5B is a detail section of a lever assembly removed from the friction clutch assembly;

FIG. 5C is a view similar to FIG. 5B but showing the lever assembly in a pivoted position;

FIG. 6 is a detail perspective of a lever assembly removed from the friction clutch assembly;

FIG. 7 is an exploded perspective of the lever assembly of FIG. 6;

FIG. 7A is a top plan view of an alternative embodiment of a plate spring of the lever assembly;

FIG. 8 is abottom plan view of a second embodiment of the friction clutch assembly;

FIG. 9 is a top perspective of a third embodiment of the friction clutch assembly;

FIG. 10 is a top plan view of the third embodiment;

FIG. 11 is a side elevation of the third embodiment;

FIG. 12 is a partial section of the third embodiment;

FIG. 13 is a top perspective of a fourth embodiment of the friction clutch assembly;

FIG. 13A is a view similar to FIG. 13 but with a portion of the cover cut away to show details of the clutch assembly;

FIG. 14 is a top plan of the clutch assembly of FIG. 13 with the clutch cover removed to show parts inside the cover;

FIG. 15 is an enlarged section taken on lines 15-15 of FIG. 14 showing the clutch in a disengaged position;

FIG. 16 is a view similar to FIG. 15 showing the clutch in an engaged position;

FIG. 17 is an enlarged section taken on lines 17-17 of FIG. 14;

FIG. 18 is an enlarged section taken on lines 18-18 of FIG. 14;

FIG. 19 is a section taken on lines 19-19 of FIG. 14;

FIG. 20 is a top perspective view of the clutch assembly with the cover removed to show primary and secondary levers of the assembly;

FIG. 21 is an enlarged perspective of a one primary lever and associated secondary (centrifugal-assist) lever; and

FIG. 22 is a schematic view of a primary lever and associated secondary (centrifugal-assist) lever.

Corresponding reference characters indicate corresponding parts throughout the several views of the drawings

### DETAILED DESCRIPTION OF PREFERRED EMBODIMENTS

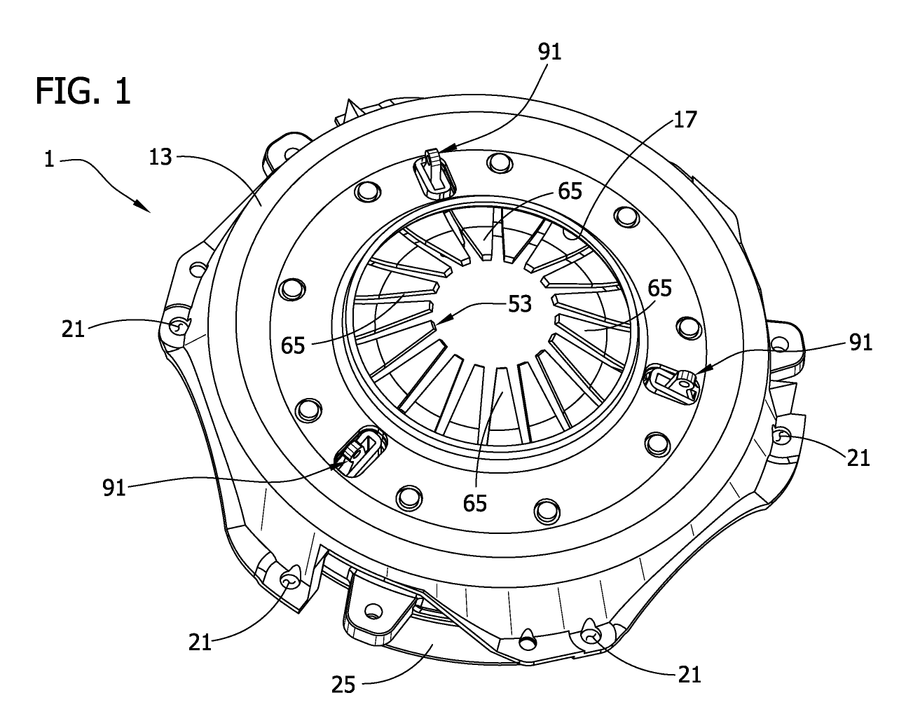

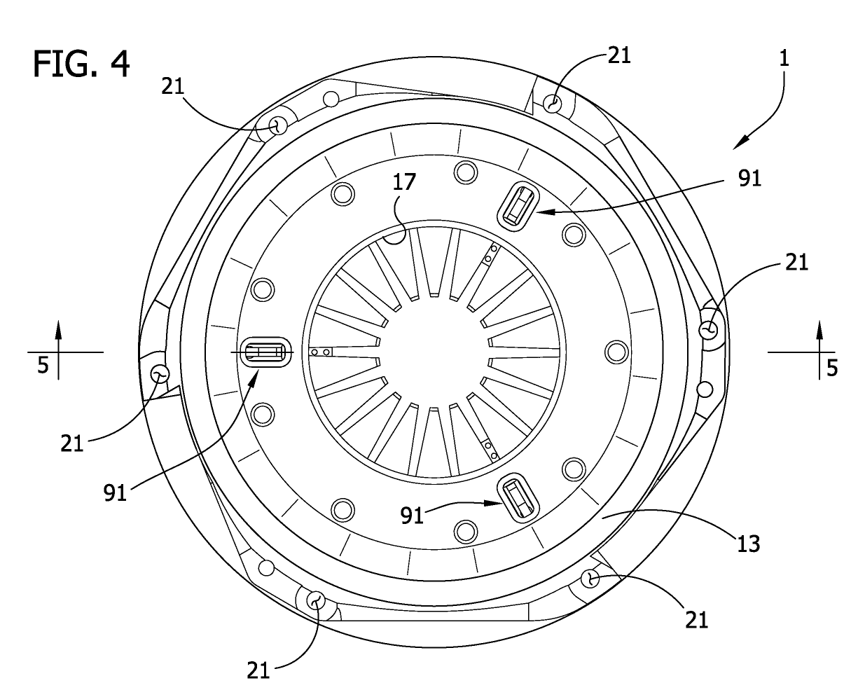

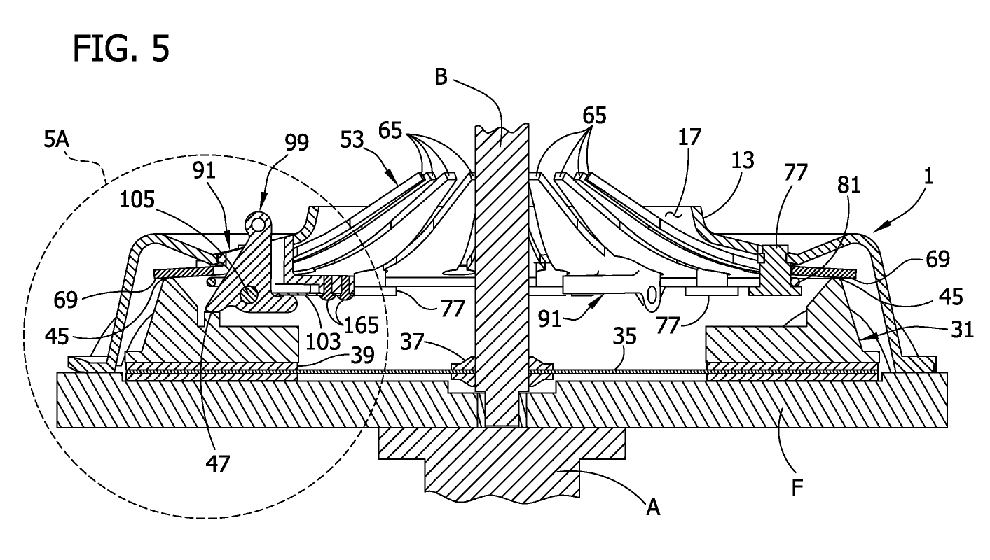

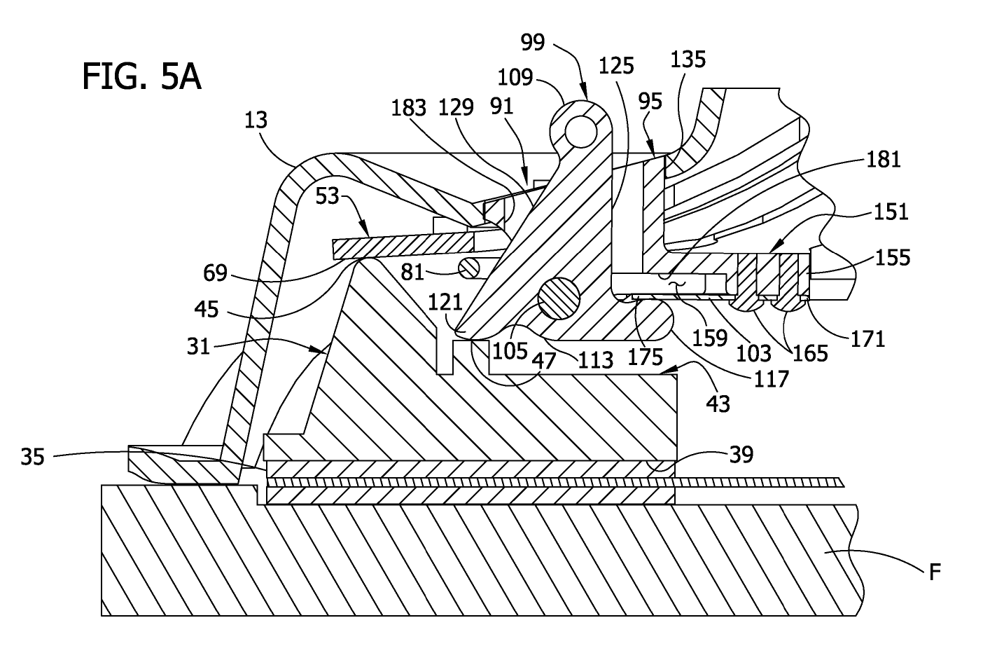

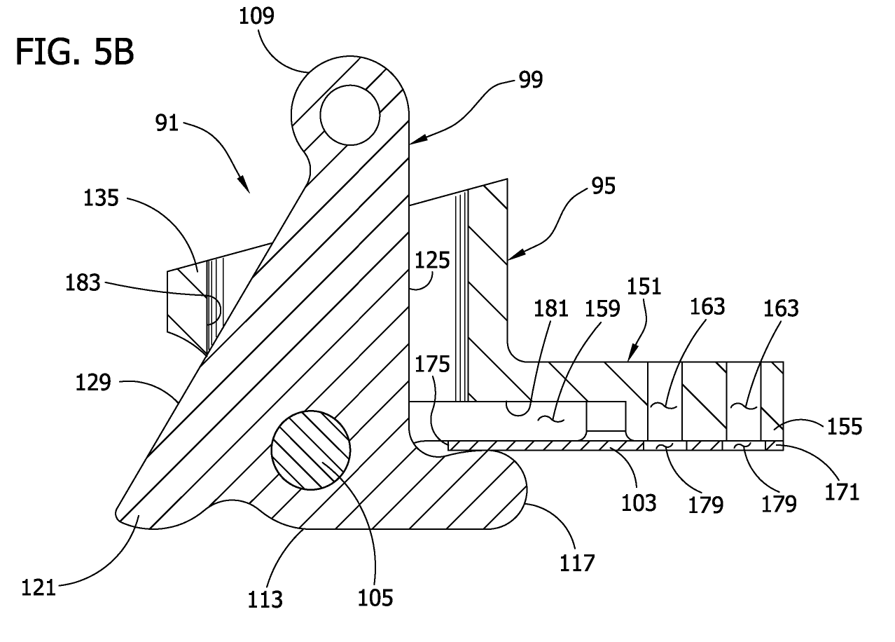

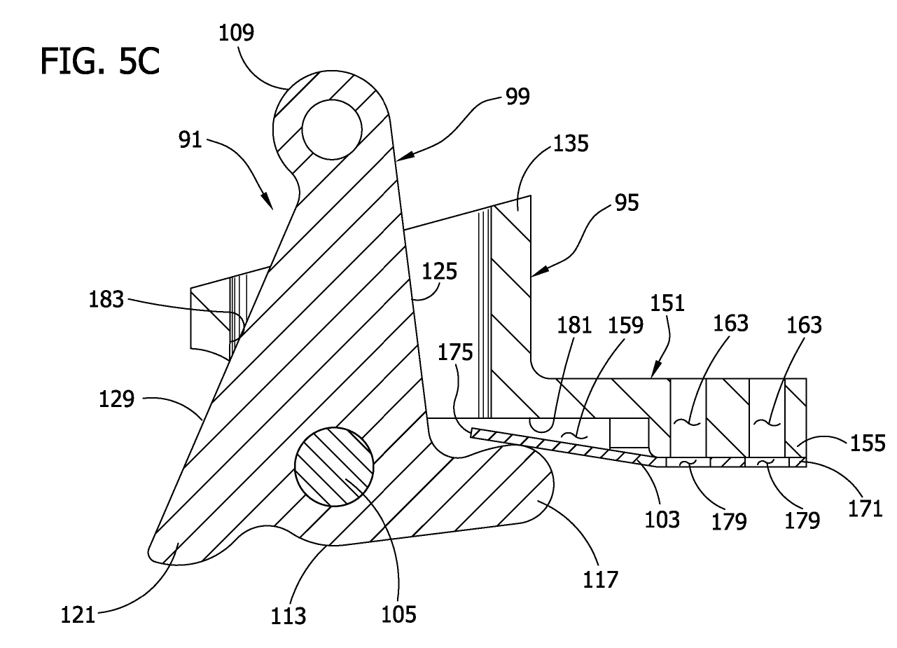

Referring now to the drawings and in particular to FIGS. 1-5, a friction clutch assembly of the present invention is indicated generally at 1. The clutch interconnects a powered, driving shaft A (FIG. 5) to a driven shaft B. Typically the driving shaft A is an engine crankshaft of an automotive vehicle (e.g., truck) which is attached to a flywheel F, and the driven shaft B is a transmission gearbox input shaft. The driving shaft A and driven shaft B are axially aligned and can be operatively connected through the clutch 1 so that torque is transmitted and the shafts rotate together. A driver of the vehicle uses the clutch 1 to selectively disconnect the shafts A, B interrupting the transmission of torque, in order to permit a gear shifting operation in the transmission.

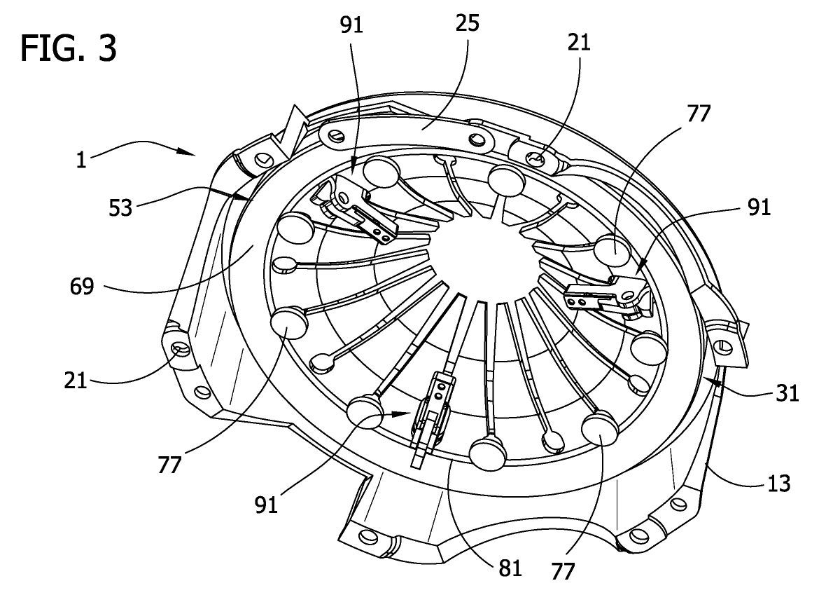

The clutch 1 includes a bowl-shaped cover 13 which is attached to the driving shaft A and which rotates with the driving shaft. It will be readily appreciated by those of ordinary skill in the art that the cover 13 could have other shapes, such as that of a flat plate. The flywheel F rotates with the engine crankshaft A and functions as a balancer for the engine, dampening vibrations and adding inertia to the crankshaft. The flywheel F provides a machined surface for contact with the clutch 1 to transmit torque to the transmission. The cover 13 generally houses the components of the clutch assembly 1 and is mounted in stationary axial position relative to the flywheel F. The cover 13 has a central opening 17 and a plurality of circumferentially spaced holes 21 for attachment to the flywheel F. Three retractor springs 25, one of which is shown in FIGS. 1 and 3, are attached to the cover by rivets (not shown) spaced around the circumference of the cover 13.

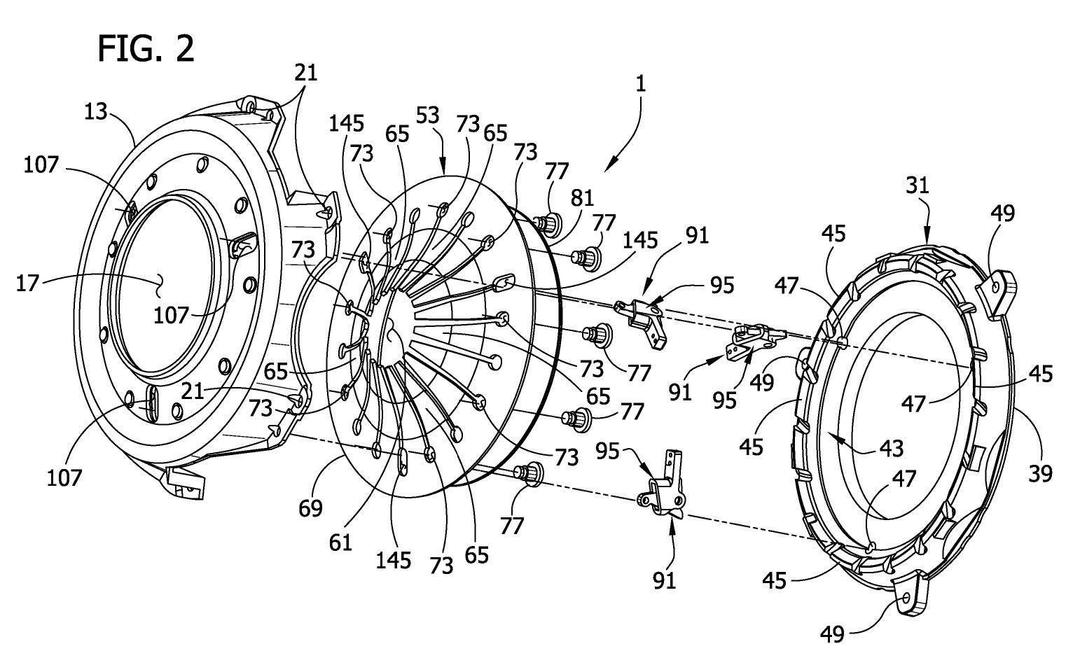

As shown in FIG. 5, a pressure plate, generally indicated 31, is adapted for selectively clamping at least one friction disk 35 in engagement against the flywheel F. The friction disk 35 is disposed between the pressure plate 31 and the flywheel F for use in interconnecting the driven shaft B and flywheel for conjoint rotation. Although only one friction disk 35 is illustrated, multiple friction disks may be used in the present invention. The friction disk 35 has a splined hub 37 that is engageable with the driven shaft B so that the friction disk rotates with the driven shaft and allows the friction disk to axially move relative to the driven shaft. The pressure plate 31 is axially moveable between an engaged position wherein the pressure plate operatively engages the flywheel F by way of the friction disk 35 thereby to transmit torque from the driving shaft A to the driven shaft B and a disengaged position wherein the friction disk is disengaged from the flywheel and substantially no torque is transmitted. As shown in FIGS. 2, 3 and 5, the pressure plate 31 is a generally annular plate with a smooth lower face 39 for contact with the friction disk and an upper face, generally indicated 43, having a plurality of raised contact surfaces 45. The upper face 43 of the pressure plate has three contact pads 47 spaced radially inward from the raised contact surfaces 45. As shown in FIG. 2, the pressure plate 31 has three angularly spaced bores 49 for receiving threaded fasteners (not shown) that attach the pressure plate to the retractor springs 25 (FIG. 3) riveted to the cover 13. The retractor springs 25 rotationally lock the cover 13 and the pressure plate 31 while permitting axial movement of the pressure plate relative to the cover and the friction disk 35.

A spring, generally indicated 53, is mounted to the cover 13 such that the spring biases the pressure plate 31 to the engaged position. In the illustrated embodiment, the spring 53 is a diaphragm spring, commonly referred to as a Belleville spring, that has a plurality of radial slots extending outward from a center opening 61 of the spring to define a plurality of radial fingers 65 that project upwardly through the central opening 17 of the cover 13. The spring 53 has a generally flat outer annular surface 69 and a plurality of apertures 73 generally near the base of the radial fingers 65. As shown in FIG. 1-5, the spring 53 is connected to the cover 13 by a plurality of rivets 77 which project through the apertures 73 and extend though openings in the cover 13. The rivets 77 secure a pivot ring 81 (FIG. 5) to the spring 53 that allows pivoting of the flat annular surface 69 in response to flexing of the radial fingers 65. In the illustrated embodiment, the spring 53 is held by the cover 13 in a position deflected from its relaxed, roughly conical configuration. As a result, the outer surface 69 of the spring is biased to press against the raised contact surfaces 45 of the pressure plate 31 to apply an axial force from the spring urging the pressure plate to the engaged position. Thus, the flat annular surface 69 of the spring functions, in effect, as a primary lever which is adapted to pivot relative to the cover 13 to apply a primary axial force to the pressure plate to move it to its engaged position. When the radial fingers 65 of the spring 53 are depressed by a release bearing (not shown) actuated by the clutch pedal of the vehicle, the flat annular surface 69 of the spring pivots away from the pressure plate 31 to allow the pressure plate to move to the disengaged position. It is believed that the clutch 1 of the present invention may be able to employ a lighter weight Belleville spring 53 for reasons described hereinafter.

In the illustrated embodiment, three lever assemblies, generally indicated 91, are circumferentially spaced around the clutch 1 so that the lever assemblies rotate with the clutch assembly at the speed of the driving shaft A. Each lever assembly 91 has a cartridge (housing), generally indicated 95, attached to the cover 13 and a centrifugal-assist lever, generally indicated at 99, pivotally attached to the cartridge that pivots against a plate spring 103 in response to centrifugal force of the rotating assembly 1. As shown in FIGS. 5 and 5A, each lever 99 is attached to the cartridge 95 by a pin 105 and is free to pivot about the pin with respect to the remaining components of the clutch assembly 1. The rotation of the clutch assembly 1 at the rotational speed of the driving shaft A causes a centrifugal force acting on each of the levers 99 that are free to pivot in a respective cartridge 95 in response to the rotation of the clutch assembly. The centrifugal force acting on each of the levers 99 causes a torque that tends to rotate each lever about the pin 105. The lever assemblies 91 are shaped and arranged such that one end of each lever 99 is in contact with the pressure plate 31 so that as each lever pivots about a respective pin 105, the torque on the lever due to the rotation of the clutch assembly is converted to an axial contact force acting on the pressure plate. Each lever assembly 91 provides a distinct secondary axial contact force acting on the pressure plate 31 that augments the primary axial force applied by the diaphragm spring 53 to urge the pressure plate toward the engaged position. In the illustrated embodiment, each cartridge 95 is received in a respective opening 107 (FIG. 2) in the cover 13 and attached to the cover by welding. It will be understood that the illustrated embodiment including lever assemblies 91 with cartridges 95 can be easily retrofit to an existing OEM clutch assembly by modifying the existing components (e.g., spring 53 and cover 13) to accommodate the cartridge. However, the present invention does not require a cartridge 95, as the lever 99 and spring 103 may be integrated with the cover 13 in the manufacture of an OEM clutch assembly.

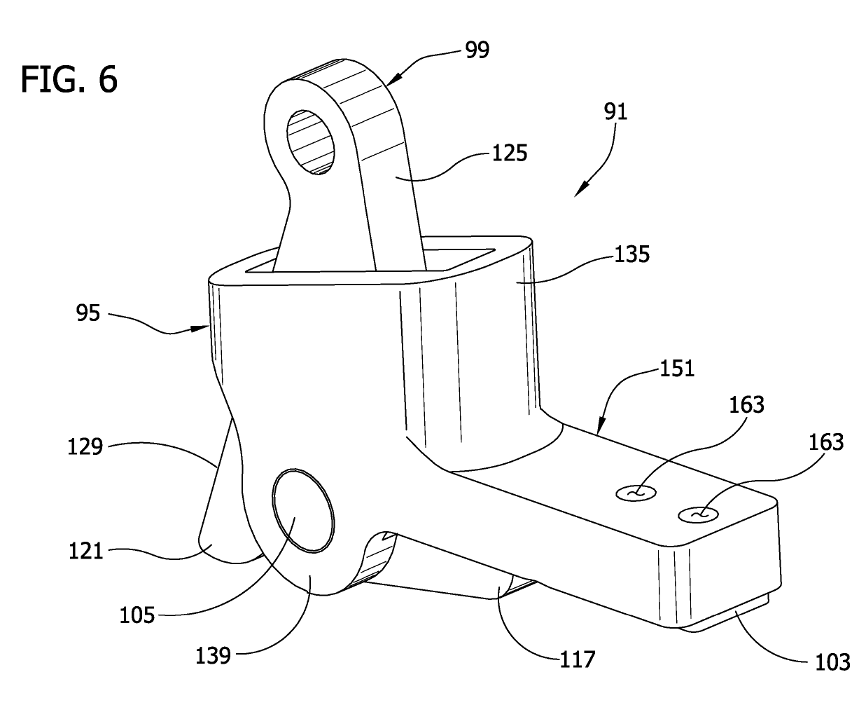

In the illustrated embodiment, each lever 99 is pivotally disposed in a tubular portion of the cartridge 95 to engage the plate spring 103 at one end and the pressure plate 31 at the other end. As shown in FIGS. 5-7, the lever 99 is a generally flat plate having a rounded head 109 protruding above the cover 13 and a base having a curved bottom surface 113, a rounded toe 117 defining the radially inward edge of the lever, and a rounded heel 121 defining the radially outward edge of the lever. In the illustrated embodiment, the lever 91 has a generally straight inward surface 125 extending downward from the head 109 to the toe 117 of the base and an inclined outward surface 129 extending downward from the head to the heel 121 of the base. As shown in FIGS. 5 and 5A, the lever 99 is configured such that the rotation of the clutch assembly 1 causes a centrifugal force tending to pivot the lever in the cartridge 95 so that the heel 121 of the lever engages the contact pad 47 of the pressure plate 31, and the toe 117 of the lever engages the spring 103. The heel 121 has a rounded contact surface with a relatively large radius of curvature (preferably about 0.25 in.) to inhibit gouging of the pressure plate 31 when the lever 99 pivots into engagement with the plate. Preferably, the lever 99 is made from heat treated steel or other suitable wear resistant material. It will be understood that the lever 99 may have other sizes and configurations so that the force applied by the lever can be adjusted.

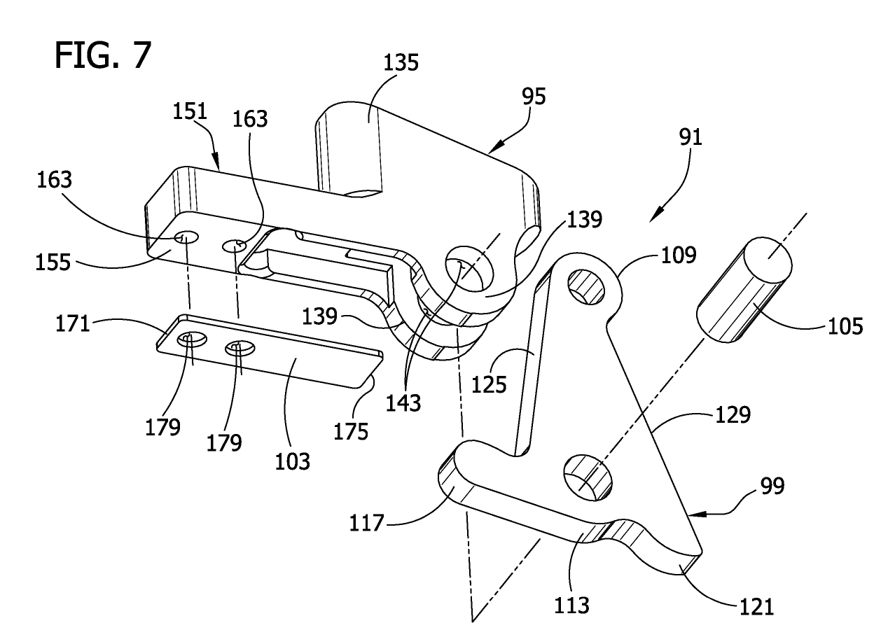

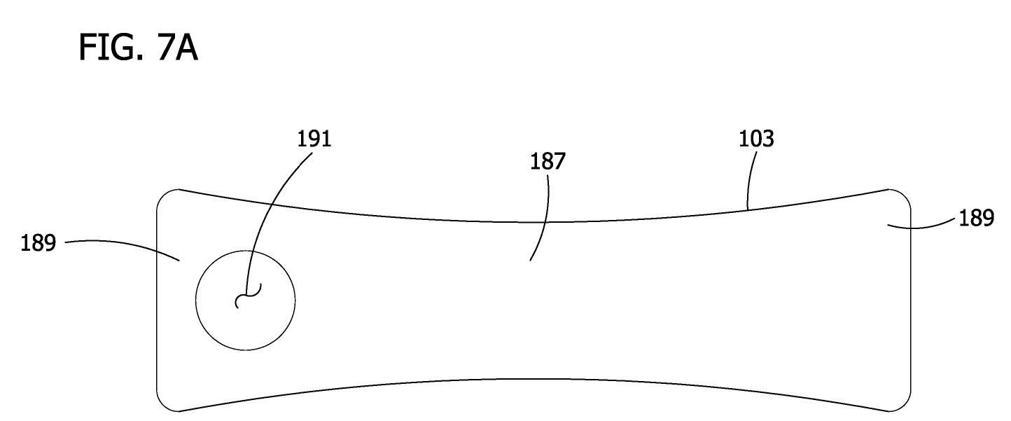

As shown in FIGS. 5-7, the cartridge 95 has a rear chamber 135 welded to the cover 13 and two protrusions 139 at the base of the rear chamber that have axially aligned openings 143 (FIG. 7) for receiving the pin 105 to pivotally connect the lever 99 to the cartridge 95. As shown in FIG. 2, the cartridge 95 is received in openings 145 between the radial fingers 65 of the diaphragm spring 53. In the illustrated embodiment, the pin 105 is held in the aligned openings 143 by an interference fit but it will be understood that the pin could be fixed in the cartridge 95 by other conventional means (i.e., press fit, stamping/end deformation, threaded end fasteners, etc.). As shown in FIGS. 5-7, the cartridge 95 has a base, generally designated 151, extending from the rear chamber 135 having a stepped bottom surface with an inward portion 155 for receiving the plate spring 103 and a raised surface forming a deflection cavity 159 adjacent the inward portion. The inward portion 155 of the base 151 has two mounting holes 163 passing through the base that receive threaded fasteners 165 (FIG. 5A) that secure the plate spring 103 to the cartridge 95. The spring 103 has a fixed end 171 attached to the inward portion 155 of the base 151, a free end 175 that is engaged by the rounded toe 117 of the lever 99, and two mounting holes 179 that receive threaded fasteners 165. As shown in FIGS. 5-5C, the cartridge 95 has two pivot stops 181, 183 that limit the pivoting motion of the lever 99 to prevent the lever from going over center and locking the clutch 1 requiring disassembly of the clutch to unlock the components. The first pivot stop 181 is formed on the raised surface of the base 151 of the cartridge 95 to restrict the counterclockwise pivoting movement of the lever 99 by limiting the amount of upward deflection of the plate spring 103. The second pivot stop 183, located in the rear chamber 135 of the cartridge 95, limits the pivoting movement of the lever 99 by contact with the inclined surface 129 of the lever. In the illustrated embodiment, the pivot stops 181, 183 are configured to limit the maximum travel of the lever 99 to approximately one thousandth of an inch. However, it will be understood that clutch designs incorporating pivot stops configured to allow more or less travel of the lever are contemplated by this invention.

The force applied by the lever assembly 91 can also be varied by the configuration and material of the spring 103 providing resistance to the pivoting motion of the lever 99. Preferably, the spring 103 is made of blue tempered SAE 1074 spring carbon steel but it will be understood that the spring may be made of other materials such as carbon steel alloys, titanium, composites, or other suitable material. By varying the bend strength of the spring material, the rotational speed at which that the lever assemblies 91 press against the pressure plate 31 can be varied. Also, the size or shape of the springs 103 can be modified to provide more or less spring force to allow selective variation of the driving shaft speed at which the lever 99 exerts force on the pressure plate 31. As shown in FIG. 7A, the spring 103 alternatively may have an hourglass shape with a narrow middle portion 187, a wider base 189 at both ends for contact with the lever 99 and the cartridge 95, and a single mounting hole 191 for attachment to the cartridge. By varying the shape of the spring 103 as shown in FIG. 7A, the stiffness of the spring is reduced so that the lever 99 acts on the pressure plate 31 at a lower rotational speed of the driving shaft A.

In operation, the cover 13 and lever assemblies 91 rotate with the driving shaft A and the centrifugal force of the lever 99 tends to pivot the heel 121 of the lever against the contact pads 47 on the upper face 43 of the pressure plate 31. The force tending to pivot the lever 99 is resisted by the engagement of the spring 103 with the toe 117 of the lever. As the rotational speed of the driven shaft B increases, the centrifugal force acting on the lever 99 increases to a point where the lever will have enough inertia to deflect the spring 103, forcing the heel 121 of the lever into engagement with the pressure plate 31. As the rotational speed of the driving shaft A increases, the spring 103 will further deflect allowing the lever 99 to apply a greater force on the pressure plate 31 at higher speeds. The force from the lever 99 acting on the pressure plate 31 urges the pressure plate to the engaged position to help prevent slippage of the clutch assembly 1 in high speed applications. By using the centrifugal force of the lever assemblies 91 to assist in urging the pressure plate 31 against the friction disk 35, the clutch assembly 1 of the present invention has increased plate loads at higher rotational speeds without requiring a larger spring 53 having higher clutch actuation forces. Thus, the clutch 1 permits transmission of larger torque between the driving shaft A and driven shaft B than prior clutches without any corresponding increase in weight or any increase in the force needed to disengage the clutch.

Preferably, the centrifugal assist force would occur just prior to the driving shaft A reaching a peak torque value for the particular vehicle in use. In one example, the clutch 1 is configured so that the centrifugal force from the lever assemblies takes effect at a driving shaft speed of approximately 2000 RPM. However, as discussed above, there could be multiple centrifugal force actuation speeds corresponding to the individual configurations and radial locations of the lever assemblies 91.

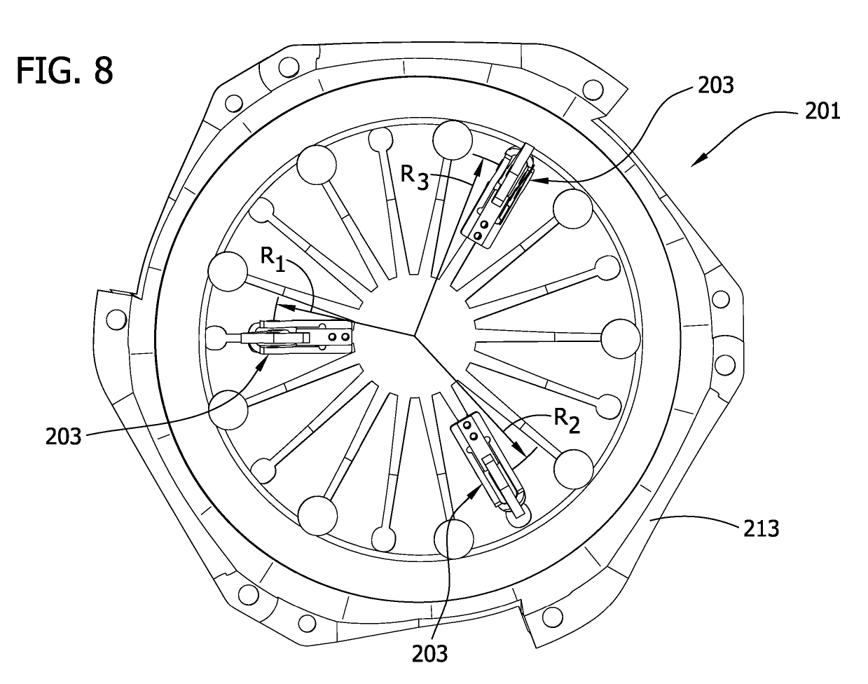

As shown in the embodiment of FIGS. 1-5, three lever assemblies 91 can be provided with approximately equal radial spacing. However, it will be understood that one, two or greater than three lever assemblies 91 could also be provided. FIG. 8 shows an exemplary alternative embodiment of the present invention, generally designated 201, having multiple lever assemblies generally designated 203 and spaced at varying radial distances R₁, R₂, and R₃ from the center of the cover 213. The variable radial spacing of the lever assemblies 203 causes each lever assembly to rotate at a respective instantaneous linear velocity and provide a distinct amount of force that is actuated at different rotational speeds of the clutch assembly 201. A strategic placement of the lever assemblies 203 at different radial distances from the center of the cover 213 allows for an incremental increase in axial force applied to the pressure plate 31 to assist retaining the pressure plate in the engaged position at incrementally higher rotational speeds of the assembly 201. For instance, the most inwardly located lever assembly 203 of FIG. 8 will have the lowest instantaneous linear velocity at a given rotational speed of the driving shaft A because the lever assembly has the shortest radial distance R₁ from the center of the cover 213. The reduced linear velocity of the most inward positioned lever assembly 203, results in comparatively less centrifugal force and resulting torque acting on the lever 99. The reduced amount of torque acting on the lever 99 of the innermost lever assembly 203 results in comparatively less axial force exerted by the lever on the pressure plate 31. In contrast, the most outwardly located lever assembly 203, located at a radial distance R₃ from the cover 213, has the highest instantaneous linear velocity and corresponding centrifugal force acting on the lever 99. The comparatively higher torque acting on the lever 99 of the outermost lever assembly 203 results in a comparatively larger axial force being exerted by the lever on the pressure plate 31.

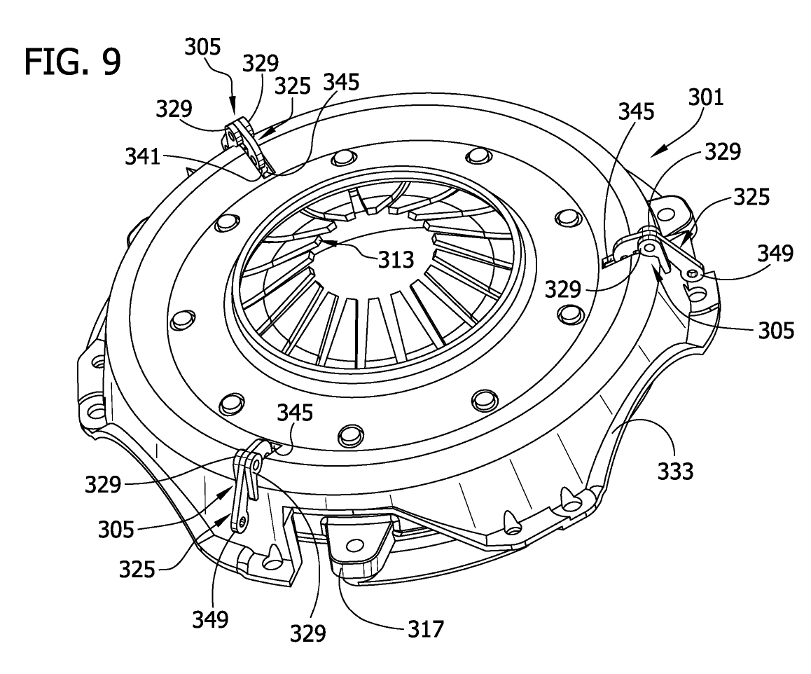

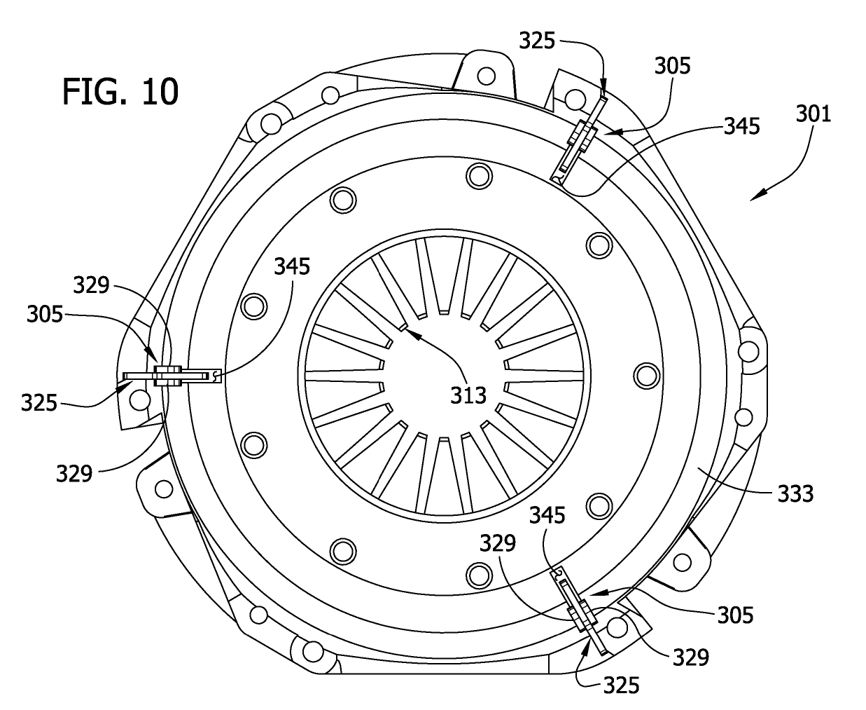

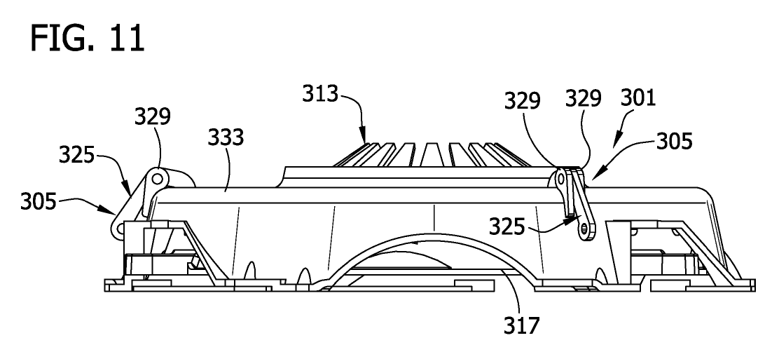

FIGS. 9-12 illustrate an alternative embodiment of the clutch assembly, generally designated 301. This embodiment is substantially similar to the clutch assembly 1 of the first embodiment except that the lever assemblies, generally indicated 305, of this embodiment are positioned for contact with the outer annular portion 309 of the diaphragm spring 313 to apply an axial force urging the pressure plate 317 to the engaged position.

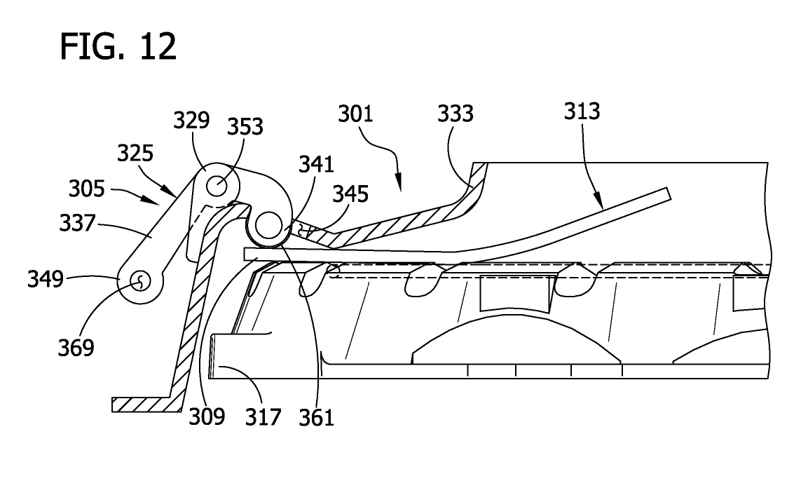

The lever assemblies 305 comprise a centrifugal-assist lever, generally indicated 325, that is pivotably attached to a housing comprising two spaced apart mounting brackets 329 attached (by welding) to the cover 333. As best seen in FIG. 12, each lever 305 comprises a generally L-shaped body 337 having a rounded head 341 protruding through an opening 345 in the cover and in contact with the outer annular portion 309 of the diaphragm spring 313 and a rounded base 349 generally located outside of the cover. The body 337 of each lever 325 is attached to the mounting brackets 329 by a mounting pin 353 that allows the lever to pivot with respect to the cover 333 and the mounting brackets. The head 341 of each lever 325 is generally housed inside the cover 333 and has a roller 361 that contacts the outer annular portion 309 of the spring 313. The roller 361 may comprise a washer or roller bearing rotatably attached to the head 341 that reduces the friction force acting on the spring 313 when the lever 325 pivots. The roller 361 prevents the lever 325 from gouging or damaging the outer annular portion 309 of the spring 313. The base portion 349 of each lever 325 has a mounting hole 369 for attaching centrifugal weights (not shown) that may be added to the lever to increase the axial force applied by the lever to the pressure plate 317.

It will be understood that the lever assemblies 305 of the clutch assembly 301 may be positioned at various radial positions similar to the lever assemblies 203 shown in FIG. 8. Also, the levers 325 may have other shapes and be otherwise positioned without departing from the scope of this invention. In general, however, as noted previously with respect to the first embodiment, the outer portion 309 of the spring 313 functions as a primary lever adapted to pivot relative to the cover for applying a primary axial force to the pressure plate 317 to urge it toward its clutch-engaged position, and the levers 325 function as secondary levers for applying secondary axial forces to the pressure plate to assist in urging it toward its clutch-engaged position. As a result, a lighter 313 spring may be used requiring less pedal force to disengage the clutch.

The present invention also includes a method of converting a clutch into a centrifugally assisted clutch as described above and shown in the drawings. The method comprises the steps of providing at least one centrifugal lever housing 95, 329 (more preferably at least three) including a lever 99, 325 pivotably attached to the housing. An opening 107, 345 is formed in an existing clutch assembly cover 13, 333 located at a radial distance from the central opening 17 of the cover corresponding with the desired radial location of the lever 99, 325. The lever 99, 325 may be inserted into the opening 107, 345 in the cover 13, 333 and the housing in the form of cartridge 95 or brackets 329 secured (as by welding) to the cover so that the housing rotates with the cover and the lever 99, 325 applies and axial force to the pressure plate 31.

If the existing clutch is to be configured for contact of the lever 99 with the pressure plate 31, contact pads 47 may be formed on the existing clutch assembly pressure plate. The contact pads 47 may be attached (as by welding) to the upper face 43 of the existing clutch assembly pressure plate 31 and aligned for contact with the lever 99. In a diaphragm spring type clutch design as shown herein, the additional step of modifying the diaphragm spring 53 (e.g., as by creating the openings 145 between adjacent fingers 65) to receive the cartridge 95 may also be required to complete the retrofit. The cartridge 95 should be positioned in the opening 107 in the cover 13 so that the lever 99 is aligned for contact with the contact pads 47 on the pressure plate 31.

If the existing clutch is to be configured for contact of the lever 325 with the spring 313 no modifications to the existing pressure plate or spring would be required. The lever 325 should be positioned in the opening 345 in the cover 333 such that the lever contacts the outer annular portion 309 of the spring 313 to provide the axial force that urges the pressure plate to the engaged position.

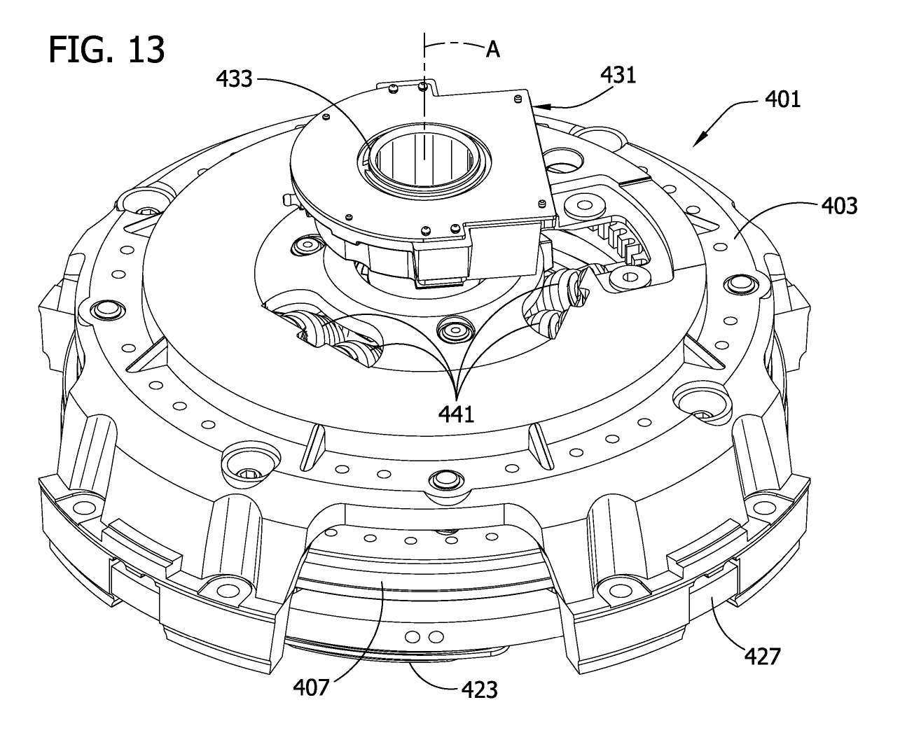

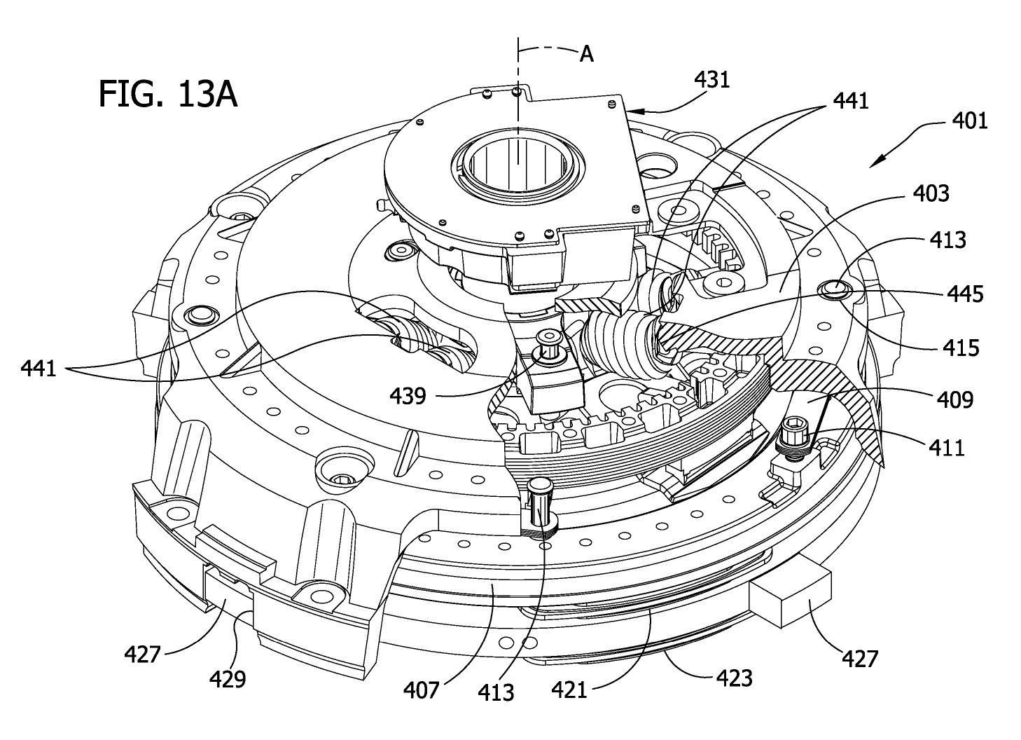

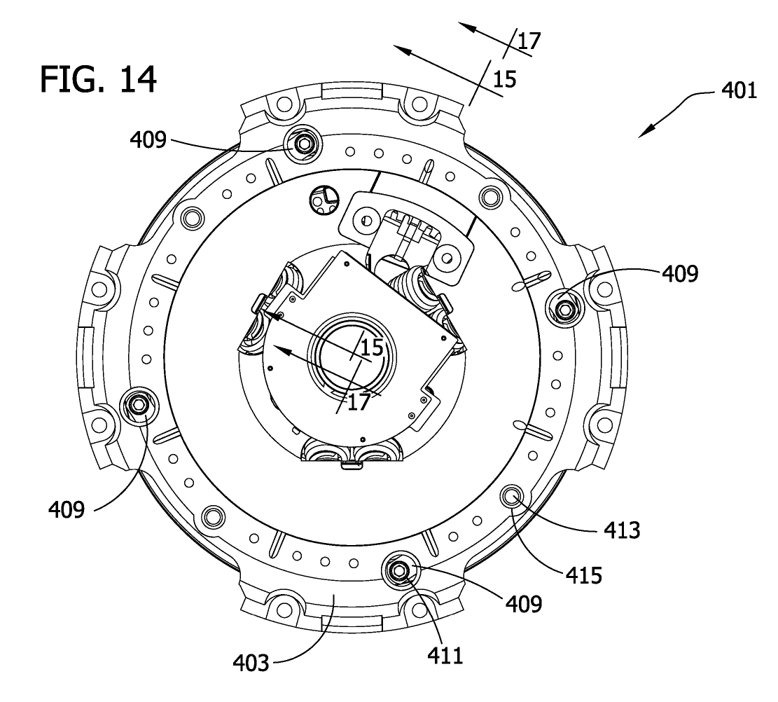

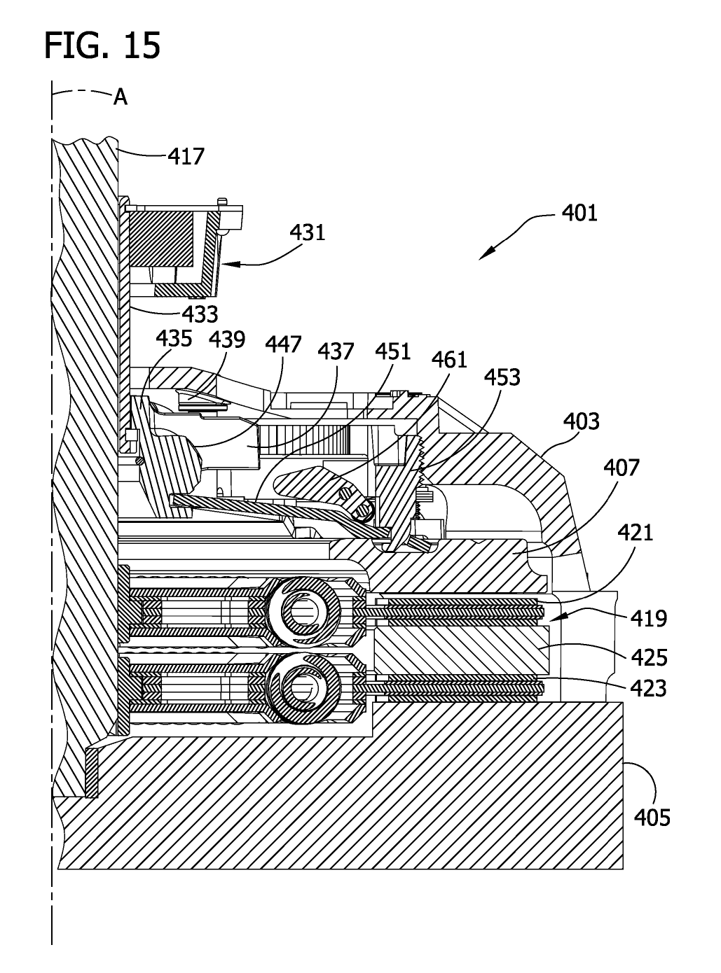

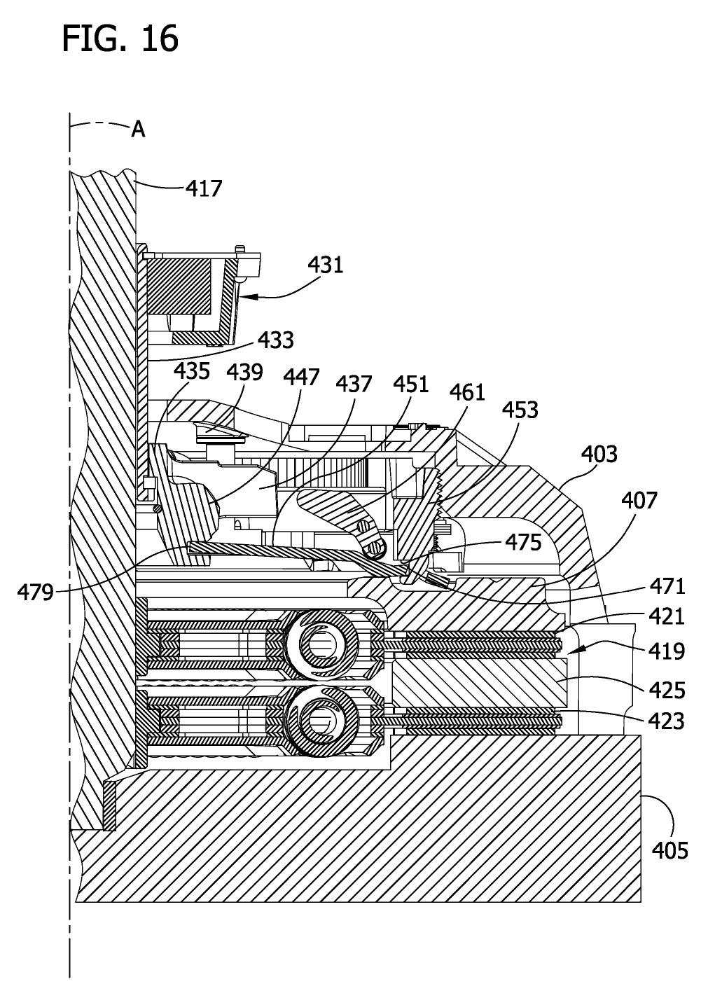

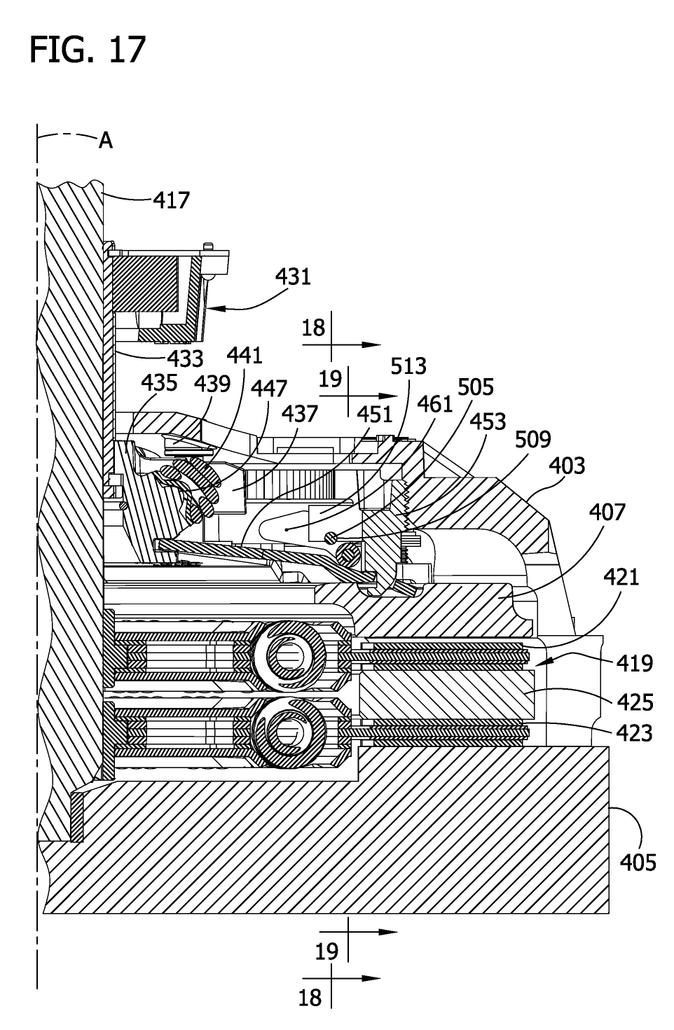

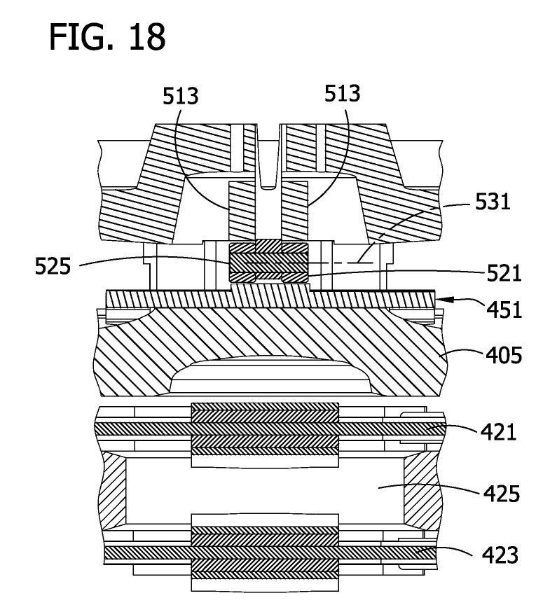

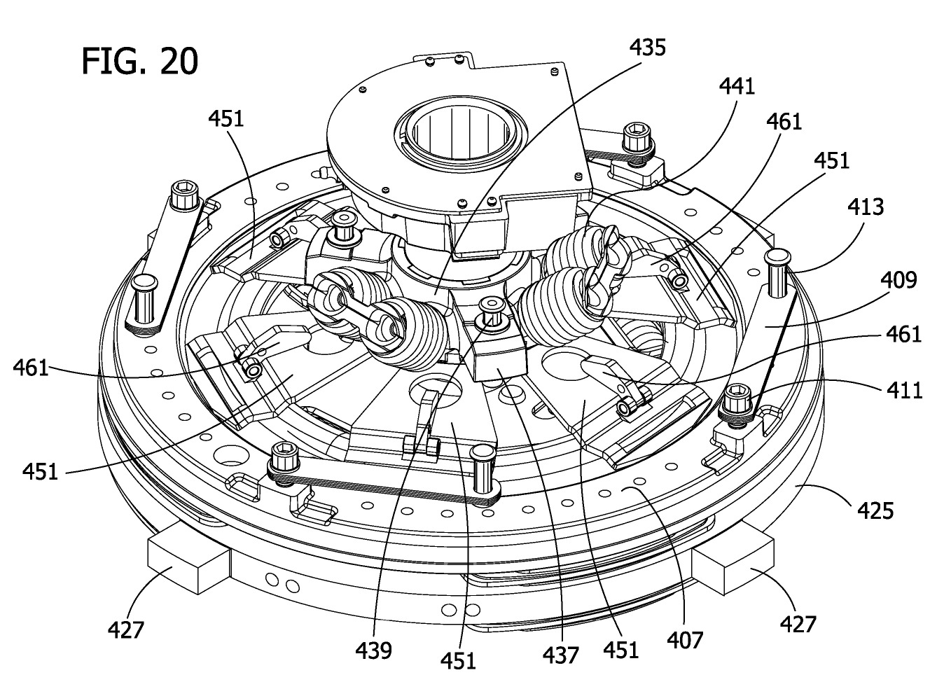

FIGS. 13-22 illustrate another embodiment of a clutch assembly of the present invention, generally designated 401. The assembly comprises a cover 403 mounted on the flywheel 405 in a fixed axial position relative to the flywheel for conjoint rotation with the flywheel, and a primary pressure plate 407 operatively attached to the cover 403 by a series of links 409 (FIGS. 13A and 20), each having a first end pivotally secured to the pressure plate 407 by a fastener 411 and a second end pivotally secured to the cover by a pin 413 on the link extending into an opening 415 in the cover. The flywheel 405, cover 403 and pressure plate 407 rotate in unison about an axis A of the driven shaft 417 (FIG. 15). The pressure plate 407 is axially moveable between an engaged position (FIG. 16) wherein the pressure plate applies a force to clamp a friction disk assembly 419 on the driven shaft 417 into operative engagement with the flywheel 405 of the driving shaft thereby to transmit torque from the driving shaft to the driven shaft, and a disengaged position (FIG. 17) wherein the pressure plate 407 does not clamp the friction disk assembly 419 and substantially no torque is transmitted. In the embodiment of FIGS. 16 and 17, the friction disk assembly 419 includes a first set of friction disks 421, a second set of friction disks 423, and an intermediate pressure plate 425 sandwiched between the two sets of friction disks 421, 423. As will be understood by the skilled person, the friction disks 419, 421 have driving connections (e.g., splined connections) with the driven shaft 417 for transmitting torque to the shaft. The intermediate pressure plate 425 has radial lugs 427 (FIG. 13A) which project into openings 429 in the cover 403, such that the plate 425 and cover 403 rotate together. It will be understood that the friction disk assembly 411 may have other configurations.

In the illustrated embodiment (see FIG. 15), the clutch assembly 401 includes a thrust bearing assembly 431 which slides on the driven shaft 417 in an axial direction in response to depression and release of the clutch pedal. The thrust bearing assembly 431 includes a sleeve 433 which is both rotatable and slidable on the driven shaft 417, and a member which, in this embodiment, comprises a retaining collar 435 affixed to the sleeve, as by splines (not shown) which prevent rotation of the collar relative to the sleeve 433 but which allow limited axial movement of the collar relative to the sleeve. The retaining collar 435 is provided with driving lugs, shown at 437 in FIGS. 13A and 15, each of which carries a pin 439 which extends into an opening in the cover 403 such that the collar 435 and sleeve 433 rotate in unison with the cover 421, as will be understood by those skilled in this field. For additional details, reference may be made to U.S. Pat. No. 3,394,788 which is incorporated herein by reference for all purposes consistent with this disclosure.

The sleeve 433 and retaining collar 435 are urged by a number of coil compression springs 441 toward the position shown in FIG. 16 in which the clutch is engaged. One end of each spring 441 is seated on a boss 445 on the cover 403 (see FIG. 13A) of the clutch and the opposite end of the spring is seated on a boss 447 on the retaining collar 435 of the thrust bearing assembly 431 (see FIG. 17). The springs 441 can be mounted in other ways. Further, the number of springs 441 may vary from two to six or more, six such springs being shown spaced around the driven shaft 417. As illustrated in FIGS. 15 and 20, a number of primary levers 451 extend between the retaining collar 435 and a member 453 on the cover 403, the member 453 in this particular embodiment being an adjustment ring threaded on the cover to move axially with respect to the cover as needed to compensate for wear of the friction disks 421, 423. Each such lever 451 is adapted to pivot relative to the cover assembly and is configured for contact with the primary pressure plate 407. The number of levers 451 may vary from one to six or more, six such levers being shown equally spaced around the axis of rotation A of the driven shaft 417. The thrust bearing assembly 431 and primary levers 451 are biased by the springs 441 to move to the clutch-engaged position shown in FIG. 16 in which each lever 451 pivots in one direction relative to the adjustment ring 453 and cover 403 thereby to apply a generally axial primary force urging the primary pressure plate 407 to its engaged position. On release of this spring bias, i.e., when the clutch is depressed to move the thrust bearing assembly 431 in a direction away from the flywheel 405, thereby compressing the springs 441, the primary levers 451 move to the clutch-disengaged position shown in FIG. 17 in which each lever pivots in an opposite direction to permit movement of the pressure plate 407 to its disengaged position.

The clutch assembly 401 further comprises at least one centrifugal-assist (secondary) lever 461 mounted on the cover. The assembly shown in the embodiment of FIGS. 13-21 includes six such secondary levers 461, one for each primary lever 451. Upon rotation of the cover 403 about its axis of rotation A, each centrifugal-assist lever 461 is operable to pivot relative to the cover to apply a generally axial secondary force to assist the primary lever 451 in urging the pressure plate 407 toward its engaged position. As a result, the force exerted by the pressure plate 407 to press the friction disk assembly 419 against the flywheel 405 is increased to provide a greater coupling force for driving the driven shaft 417. As a result, smaller and/or fewer springs can be used to maintain the clutch engaged. This is advantageous because less force is required to disengage the clutch, making the gear-shifting process easier and less fatiguing.

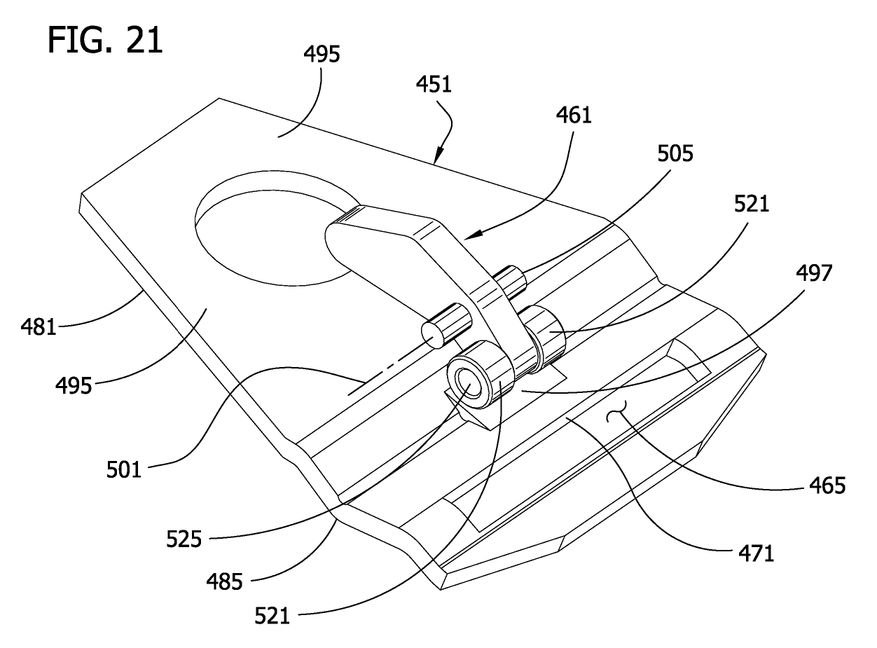

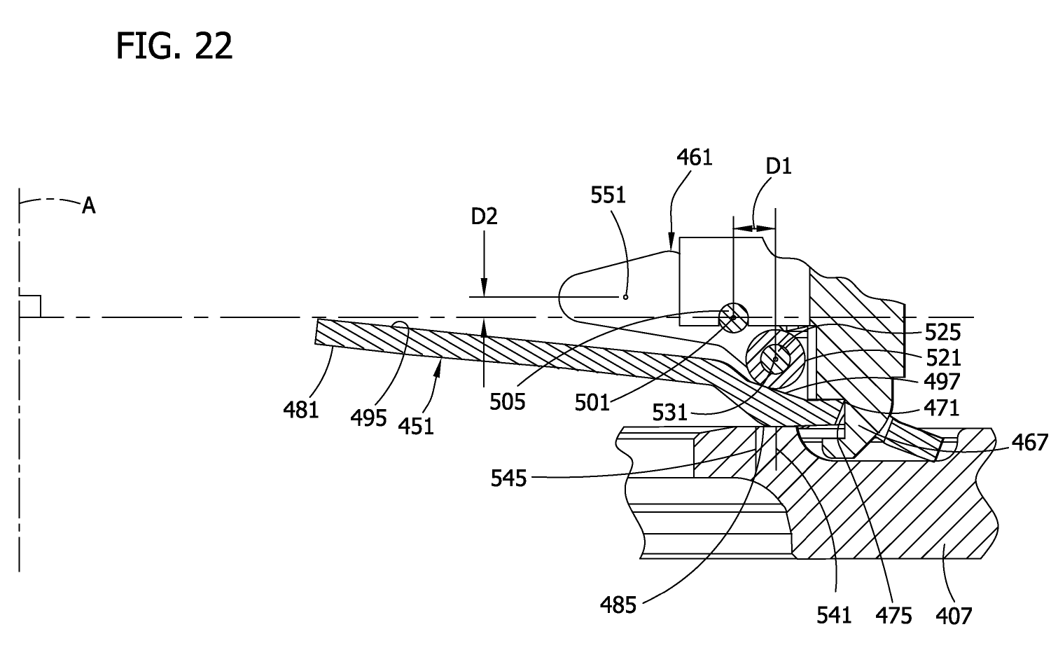

Referring to FIGS. 20 and 21, each primary lever 451 is shown as being generally wedge shaped, having a relatively wide outer end with an opening 465 for receiving a lug 467 depending from the adjustment ring 453, and a relatively narrower inner end adjacent the retaining collar 435. Referring to FIGS. 21 and 22, the lever 451 may be formed as a one-piece member stamped from a sheet of metal, or otherwise formed. The radial inner surface defining the opening 465 in the lever 451 has a knife edge 471 received in a notch 475 in the lug 467 on the adjustment ring. Alternatively, the knife edge 471 could be received in a recess in some other member on the cover 403, and such member could be a part which is separate and discrete from the cover or a part which is formed as an integral portion of the cover. The inner end of the lever 451 is received in a circumferential recess 479 in the retaining collar 435. The primary lever 451 has a first surface 481 comprising a fulcrum area 485 configured for pivoting contact with a corresponding contact area 491 of the primary pressure plate 407, and an opposite second surface 495 comprising a contact area 497 configured for pressure contact by a corresponding centrifugal-assist lever 461. In one embodiment, and for reasons which will appear, the contact area 497 of the primary lever 451 adapted for contact by the centrifugal-assist lever 461 is sloped to form a ramp (see FIGS. 21 and 22).

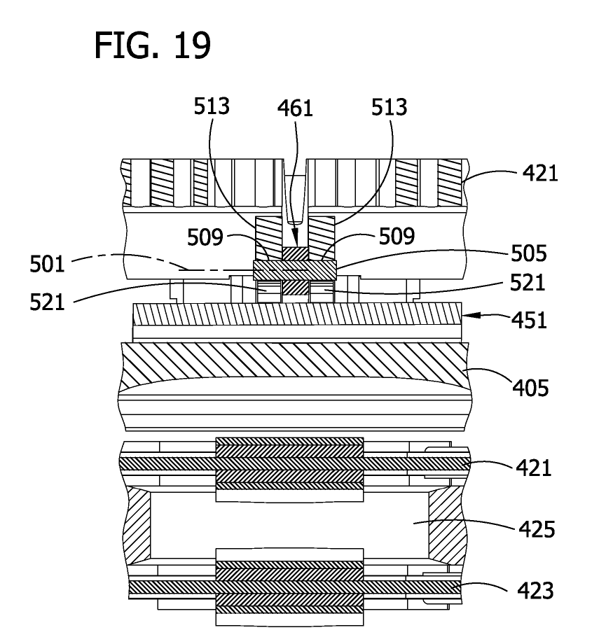

In the embodiment of FIGS. 13-21, each secondary centrifugal-assist lever 461 is flat, relatively thin, and has a first (outer) end generally adjacent the adjustment ring 453 and cover 403 and an opposite second (inner) end toward the retaining collar 431. The lever 461 is mounted on the cover for pivotal movement of the lever about a pivot axis 501 (FIGS. 21 and 22) between the clutch-engaged position shown FIG. 16, and the clutch-disengaged position shown in FIG. 17. In one embodiment, a pivot shaft 505 is affixed to the lever 461, and the ends of the shaft are rotatably received in a pair of notches 509 (FIGS. 17 and 19) in opposing ears 513 of a clevis-type structure on the adjustment ring 465. At least one roller and preferably two rollers 521 are mounted on a shaft 525 affixed to the lever 461 generally adjacent its first (outer) end for rotation about an axis 531 and for rolling contact with the ramped contact area 497 of the primary lever 451, as shown in FIG. 21. The rolling contact reduces friction and wear between the two parts.

The size, shape and geometry of the centrifugal-assist lever(s) 461 can vary, depending on the space available, amount of secondary force to be applied by the lever to the pressure plate, and other factors. FIG. 22 schematically illustrates one embodiment of the centrifugal-assist lever 461 and associated primary lever 451. In this embodiment, the fulcrum area 485 of the primary lever 451 has a radial outer boundary 541 and a radial inner boundary 545. As the primary lever 451 pivots, the location of contact between the fulcrum area 485 of the lever and the contact area 491 of the pressure plate 407 will vary between the two boundaries 541, 545. For optimal pressure distribution over the contact area 491 of the pressure plate 407, the contact area 497 of the primary lever 451 opposite the fulcrum area 485 is preferably located directly over the fulcrum area 485 so that the contact area and the fulcrum area are at least partially co-extensive (overlapping) in the radial direction with respect to axis A. Preferably, the fulcrum area 485 remains at a location radially inward of the roller axis 531 of the centrifugal-assist lever 461 to insure that the knife edge 471 of the primary lever 451 remains properly positioned in the notch 475 of the lug 467 on the adjustment ring 453 as the lever 451 pivots between its clutch-engaged and clutch-disengaged positions.

It will also be observed in FIG. 22, showing various parts in a clutch-engaged position, that the pivot axis 501 of the centrifugal-assist lever 461 is spaced a radial distance D1 inward from the roller axis 531. (This distance D1 will vary somewhat depending on the pivot position of the lever 461.) The magnitude of this distance D1 can be varied to change the magnitude of the secondary force applied by the lever 461 to the lever 451. The amount of secondary force will also depend on the location of the center of mass 551 of the centrifugal-assist lever 461. In the embodiment of FIG. 22, the center of mass 551 is located radially inward from the pivot axis 501, and radially inward from the fulcrum and contact areas 485, 497 of the primary lever 451. In general, the center of mass 551 is disposed a distance D2 above a radial line through the pivot axis 501 of the lever 461. (This distance D2 will change depending on the pivot position of the lever 461.) The specific geometry of the lever 461 and the various locations of its pivot and roller axes 501, 531 and center of mass 551 can be varied depending on the required secondary force to be applied by the centrifugal-assist lever. Further, while the lever 461 is shown as having a generally dog-leg shape, the shape may vary as needed or desired.

Regardless of the shape of each centrifugal-assist lever 461, it is preferable (although not essential) that the lever be configured so that it remains entirely within the cover 403 as it pivots between its clutch-engaged and clutch-disengaged positions. This configuration provides greater compactness to the clutch assembly and avoids interference with other parts of the clutch.

When the clutch is engaged, the primary and secondary levers 451, 461 assume the positions shown in FIG. 16, in which the fulcrum area 485 of each primary lever 451 contacts the primary pressure plate 407 and exerts a primary axial force on the pressure plate, and in which each secondary (centrifugal-assist) lever 461 contacts a respective primary lever 451 to exert a secondary axial force on the pressure plate 407. Thus, the total pressure exerted on the primary pressure plate 407 by the levers 451, 461 will be the sum of the primary axial forces exerted by the primary levers 451 plus the sum of the secondary axial forces exerted by the secondary levers 461. As the speed of rotation of the assembly increases, the centrifugal force exerted on each secondary lever 461 will cause it to pivot with increasing force in one direction about its pivot axis 501 (clockwise as viewed in FIG. 22), thus exerting an increasing axial force against a respective primary lever 451 to assist the primary lever in applying an axial force to the pressure plate 407. Preferably, for the sake of uniform load distribution on the pressure plate 407, the primary axial forces exerted by the primary levers 451 are about the same from lever to lever, and the secondary axial forces exerted by the secondary levers 461 are about the same from lever to lever, although it is contemplated that there may some variation between levers. As the rotation of the clutch assembly decreases, as during a shifting event, the centrifugal force on each secondary lever 461 decreases, resulting in a decreasing axial force on the pressure plate 407. Depression of the clutch pedal causes movement of the thrust bearing assembly 431 in a direction away from flywheel, with concurrent compression of the springs 441, to permit disengagement of the clutch to permit the shifting event to occur. After the event has been completed, the clutch pedal is released, and the springs 441 urge the clutch assembly back to its engaged position. As noted previously, because the secondary levers 461 assist in providing the necessary axial force against the pressure plate 407 to maintain the proper coupling between the pressure plate and the flywheel (through the friction disk assembly 419), the springs 441 can apply less force to the thrust bearing assembly 431 compared to conventional designs. As a result, less effort is required by the driver to disengage the clutch, and driver fatigue over time is reduced.

In view of the above, it will be seen that the several objects of the invention are achieved and other advantageous results obtained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense. For example, one or more lever assemblies 91 constructed in accordance to the present invention may be retrofit to a cover 13 of an existing clutch assembly. Also, the present invention could include lever assemblies 91 incorporated into the cover 13 without requiring a cartridge 95 housing the individual components of the lever assemblies. The clutch assembly 1 of the present invention may be used in many different applications including automotive, motorcycle, marine, industrial, or any type of application requiring a clutch assembly for transmitting torque from a driving shaft A to a driven shaft B. The present invention 1 may also be used with all types of clutches including Belleville or diaphragm spring, coil spring, push or pull, single or multiple plate, or any other type of clutch.

What is claimed is:

1. A friction clutch assembly for connecting driving and driven shafts, said driving shaft having a flywheel thereon, said friction clutch comprising:
a cover adapted to be secured to the flywheel in a fixed axial position relative to the flywheel and for conjoint rotation with the flywheel about an axis of rotation of the driven shaft;
a pressure plate adapted for operative attachment to said cover for rotation therewith about said axis of rotation, the pressure plate being axially moveable between an engaged position wherein the pressure plate applies a force to clamp a friction disk on said driven shaft into operative engagement with said flywheel thereby to transmit torque from the driving shaft to the driven shaft, and a disengaged position wherein the pressure plate does not clamp said friction disk and substantially no torque is transmitted;
at least one primary lever adapted to pivot relative to the cover and configured for contact with said pressure plate;
said at least one primary lever being spring-biased to pivot in one direction relative to said cover thereby to apply a generally axial primary force urging the pressure plate to said engaged position, and being adapted to pivot upon release of said spring bias to pivot in an opposite direction thereby to permit movement of said pressure plate to said disengaged position; and
at least one centrifugal-assist lever operable on rotation of the cover to pivot relative to the cover to apply a generally axial secondary force to said primary lever to assist in urging said pressure plate to said engaged position.

2. The clutch assembly as set forth in claim 1 wherein said at least one primary lever comprises a plurality of primary levers, and wherein said at least one centrifugal-assist lever comprises at least one such centrifugal-assist lever for each of said primary levers.

3. The clutch assembly as set forth in claim 1 wherein said at least one primary lever comprises a first end adapted for contact with a member on said cover and a second end opposite the first end adapted for contact with a member of a thrust bearing assembly on said driven shaft.

4. The clutch assembly as set forth in claim 3 further comprising a plurality of coil compression springs, each having one end seated on said cover and another end seated on said member of said thrust bearing assembly for urging said member in a direction in which said at least one primary lever applies said primary axial force to said pressure plate.

5. The clutch assembly set forth in claim 1 wherein said at least one centrifugal-assist lever is contained entirely inside said cover.

6. The centrifugal lever assembly set forth in claim 1 wherein said at least one centrifugal-assist lever comprises a roller adapted for rolling contact with said at least one primary lever.

7. The centrifugal lever assembly set forth in claim 6 wherein said at least one primary lever comprises a ramp for rolling contact by said roller.

8. The centrifugal lever assembly set forth in claim 1 wherein said at least one primary lever has a first surface comprising a fulcrum area configured for pivoting contact with said pressure plate, and an opposite second surface comprising a contact area configured for pressure contact by said at least one centrifugal-assist lever, said fulcrum and contact areas being at least partially co-extensive in a radial direction with respect to said axis of rotation.

9. The centrifugal lever assembly set forth in claim 8 wherein said at least one centrifugal-assist lever comprises a roller adapted for rolling contact with the contact area of said at least one primary lever.

10. The centrifugal lever assembly set forth in claim 9 wherein said contact area of said at least one primary lever comprises a ramp for rolling contact by said roller.

11. The centrifugal lever assembly set forth in claim 9 wherein said fulcrum area has a radial inner boundary and a radial outer boundary, and wherein said roller rotates about a roller axis located radially inward of said radial outer boundary.

12. The centrifugal lever assembly set forth in claim 11 wherein roller rotates about a roller axis located radially outward of said radial inner boundary.

13. The centrifugal lever assembly set forth in claim 8 wherein said at least one centrifugal-assist lever pivots about a pivot axis located radially inward of said fulcrum and contact areas of said primary lever.

14. The centrifugal lever assembly set forth in claim 13 wherein said at least one centrifugal-assist lever has a center of mass located radially inward of said pivot axis, and radially inward of said fulcrum and contact areas of said primary lever.
